(19) United States
(12) Patent Application Publication
(10) Pub. No.: US 2010/0106350 A1
(43) Pub. Date: Apr. 29, 2010

(54) Real-time efficiency monitoring for marine vessel

(75) Inventor: Gerald Allen Alston, Alameda, CA (US)

Correspondence Address: FOLEY AND LARDNER LLP;SUITE 500, 3000 K STREET NW, WASHINGTON, DC, 20007, US

(73) Assignee: GLACIER BAY, INC.

(21) Appl. No.: 12/588,754

(22) Filed: Oct. 27, 2009

Related U.S. Application Data
(60) Provisional application No. 61/193,100, filed on Oct. 28, 2008.

(51) Int. Cl. G06F 17/00; G06F 19/00; G01C 21/00; G01F 23/00

(52) U.S. Cl. 701/21; 701/213; 73/290 R; 73/114.54

(57) ABSTRACT

A propulsion system for a marine vessel comprising an engine driving a generator for supplying electrical power to a propulsion motor, an operator display, a fuel consumption sensor, a vessel position sensor, a vessel speed sensor, and a controller configured to receive inputs from the fuel consumption, vessel position and vessel speed sensors and calculate the vessel's efficiency through water and efficiency over land, wherein both efficiency values are displayed on the operator display as volume of fuel consumed per distance traveled (over land or through the water).

### CROSS-REFERENCE TO RELATED PATENT APPLICATION

This application claims the benefit of and priority to U.S. Patent Application No. 61/193,100, filed Oct. 28, 2008, incorporated herein by reference in its entirety.

### BACKGROUND

The present application relates generally to the field of marine vessels. More specifically, the present invention relates to a propulsion system for a marine vessel which provides substantially instantaneous monitoring of efficiency of the propulsion system.

### SUMMARY

One disclosed embodiment relates to a propulsion system for a marine vessel, which includes an engine driving a generator for supplying electrical power to a propulsion motor, an operator display, a fuel consumption sensor, a vessel position sensor, a vessel speed sensor, and a controller configured to receive inputs from the fuel consumption, vessel position and vessel speed sensors. The controller is further configured to calculate the vessel's efficiency through water and efficiency over land, wherein both efficiency values are displayed on the operator display as volume of fuel consumed per distance traveled (over land or through the water).

Another embodiment of a propulsion system for a marine vessel further includes a generator electrical load sensor, wherein the controller is configured to calculate the fuel consumption per unit of electrical power generated by the generator, whereby the calculated fuel consumption value is displayed on the operator display.

Another embodiment for a propulsion system for a marine vessel further includes a Global Positioning System (GPS) based navigation system, wherein the controller is configured to calculate the fuel required to destination and wherein the required fuel is displayed on the operator display.

### BRIEF DESCRIPTION OF THE DRAWINGS

FIG. 1 is a block diagram of an electrical system for a marine vessel according to an exemplary embodiment.

FIG. 2 is a block diagram of an electrical system for a marine vessel according to another exemplary embodiment.

FIG. 3 is a block diagram of a portion of a propulsion system for a marine vessel according to an exemplary embodiment.

FIG. 4 is a block diagram of an operator display for use in the propulsion system of FIG. 3.

FIG. 5 is a block diagram of a portion of a propulsion system for a marine vessel according to another exemplary embodiment.

FIG. 6 is a block diagram of an operator display for use in the propulsion system of FIG. 5.

FIG. 7 is a block diagram of a portion of a propulsion system for a marine vessel according to another exemplary embodiment.

FIG. 8 is a block diagram of an operator display for use in the propulsion system of FIG. 7.

### DETAILED DESCRIPTION

One embodiment relates to a propulsion system for a marine vessel. The propulsion system comprises an engine driving a generator for supplying electrical power to a propulsion motor; an operator display; a fuel consumption sensor; a vessel position sensor; a vessel speed sensor; and a controller. The controller is configured to receive inputs from the fuel consumption, vessel position and vessel speed sensors and calculate the vessel's efficiency through water and efficiency over land, wherein both efficiency values are displayed on the operator display as volume of fuel consumed per distance traveled (over land or through the water). The system further comprising a generator electrical load sensor, wherein the controller is configured to calculate the fuel consumption per unit of electrical power generated by the generator and whereby the calculated fuel consumption value is displayed on the operator display. The controller is configured to calculate the fuel consumption per unit time, whereby the fuel consumption value is displayed on the operator display. The system further comprises a fuel tank level sensor. The controller is configured to calculate the distance remaining before the fuel tank is empty, whereby the distance remaining is displayed on the operator display. The system further comprises a GPS based navigation system, wherein the controller is configured to calculate the fuel required to destination and whereby the required fuel (to destination) is displayed on the operator display.

In another embodiment, a propulsion system for a marine vessel comprises an engine driving a generator for supplying electrical power to a propulsion motor, wherein the motor drives a shaft attached to a propeller; an operator display; a fuel consumption sensor; a generator electrical load sensor; a sensor for measuring the thrust on the shaft (e.g., a pressure sensor at thrust bearing); and a controller configured to receive inputs from the sensors to calculate the propulsion system efficiency and display the calculated value on the operator display.

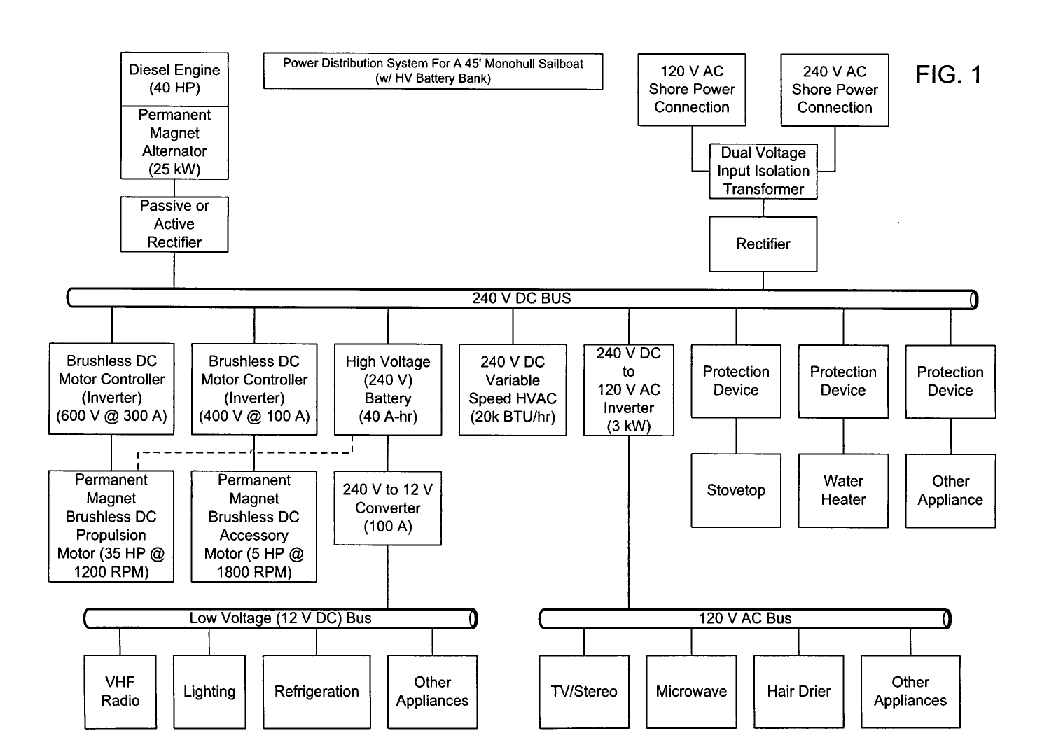

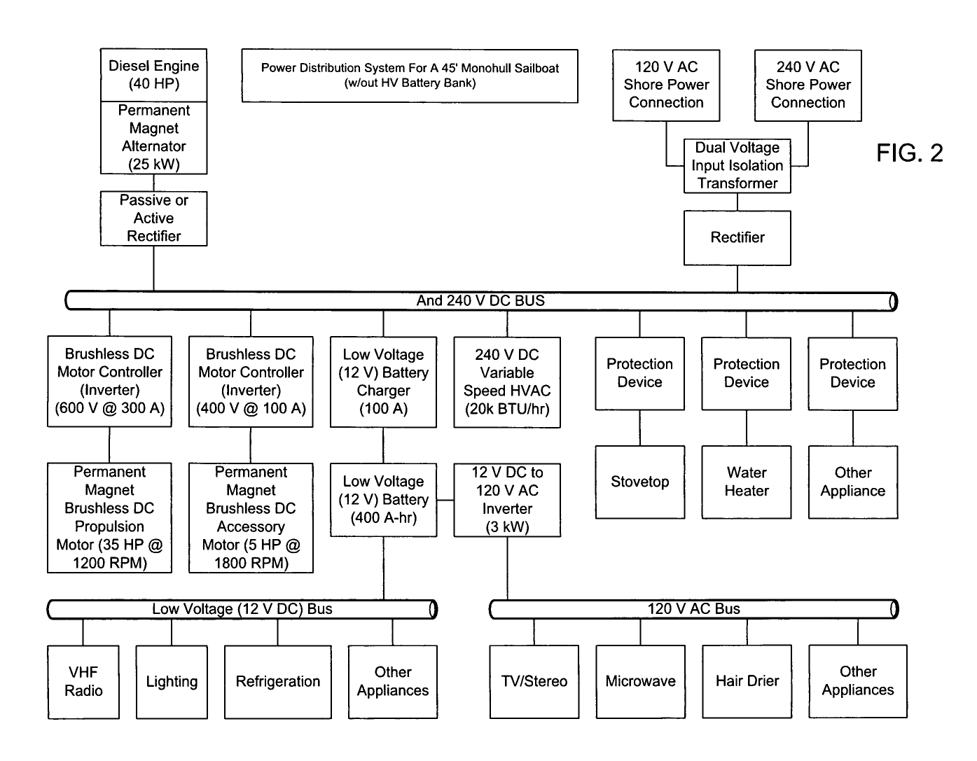

Referring to FIGS. 1 and 2, block diagrams of electrical systems for marine vessels are shown according to exemplary embodiments. The marine (e.g., sailing) vessel includes an on-board propulsion system 20 to power a propulsion motor 27, which provides torque and power to drive at least one propeller. According to an exemplary embodiment, propulsion system 20 includes a generator 25 for providing work and power to propulsion system 20, where the generator or alternator 25 may be driven (i.e., powered) by an engine 23, which may include a driveshaft coupled to rotate a permanent magnet in generator 25. According to an exemplary embodiment, engine 23 may be a 40 horsepower diesel engine. According to other embodiments, engine 23 may be configured to provide any amount of horsepower and may be a diesel engine or any internal combustion engine (e.g., gasoline engine). The generator 25 may power, for example, a 240 V DC bus in the vessel. As shown in FIG. 1, the vessel may include a rechargeable energy source, such as a battery or a plurality of batteries, to store energy from the generator 25. According to an exemplary embodiment, propulsion motor 27 may be an electric motor, such as a brushless DC permanent magnet motor, configured to provide torque and power to drive at least one propeller through a driveshaft. The propulsion motor 27 may be coupled to the bus through a controller, and may be configured to receive power from the rechargeable energy source when the engine 23 and generator 25 are not operating (e.g., turned off, malfunctioning).

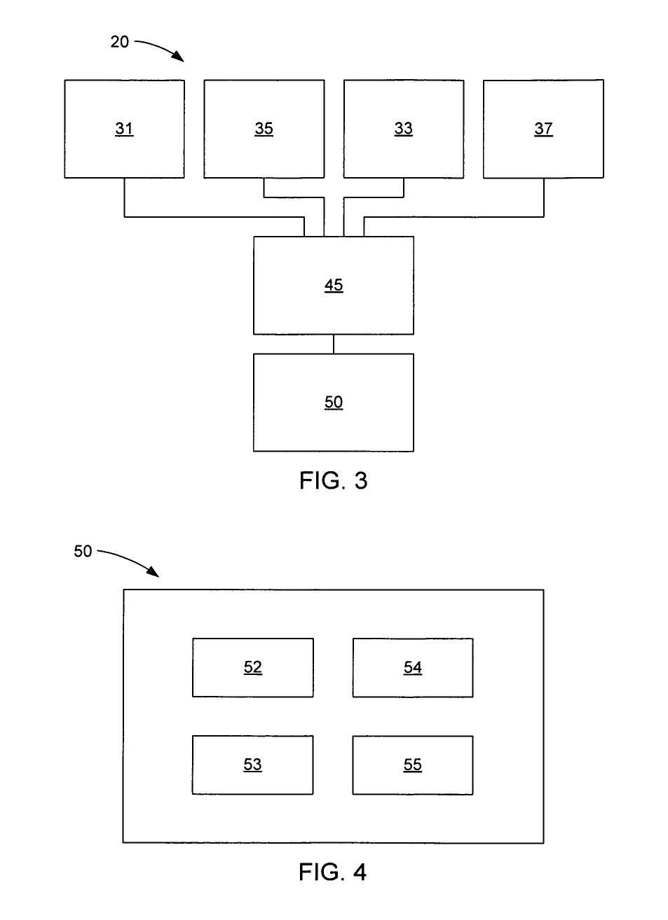

The efficiency of the propulsion system can be affected by various factors. For example, engine speed, wind speed, and water current all contribute to the overall efficiency of propulsion system 20. By monitoring the various criteria associated with the performance of the generator, the vessel speed over water, and the vessel speed over land; and then displaying the results in real time, a user may adjust the propulsion system of the vessel to maximize or otherwise adjust performance and/or to improve efficiency of the propulsion system. As shown in FIGS. 3, 5, and 7, controllers 45, 145, 245 receive signals from a plurality of sensors 31, 33, 35, 37, 38, 39 and use the information received from the sensors to calculate various data that may be shown on operator displays 50, 150, 250 (as shown in FIGS. 4, 6, and 8), which may be observed by any user of the vessel.

Referring to FIG. 3, propulsion system 20 is shown, according to an exemplary embodiment, to include a fuel consumption sensor 31, a vessel speed sensor 35, a position sensor 33, a generator electrical load sensor 37, a controller 45, and an operator display 50. Propulsions system 20 may further include a propulsion motor 27 and a generator 25, which includes engine 23 (not shown in FIG. 3). The sensors may detect data, as disclosed below, then communicate the data by signals to the controller 45 that analyzes the signals and communicates the processed data by signals to operator display 50 where it can be viewed by a user. According to an exemplary embodiment, the sensors may communicate the signal of detected data through at least one wiring harness directly coupled to controller 45. According to another exemplary embodiment, the sensors may communicate the signals of detected data wirelessly (e.g., RFID) to controller 45. Additionally, the controller 45 may communicate the signals of processed data to the operator display 50 through at least one directly coupled wiring harness or through remote (e.g., wireless) means.

Fuel consumption sensor 31 detects the rate at which the generator 25 consumes fuel (i.e., fuel consumption per unit time). Fuel consumption sensor 31 may measure the on-time of the fuel injectors, the flow rate of fuel from the fuel reservoir to engine 23, or any other criteria that suitably allows the rate of consumption of fuel to be calculated. According to an exemplary embodiment, fuel consumption sensor 31 may detect the fuel consumption measured as a volume (e.g., gallons, liters) consumed per unit time (e.g., hour, minute). According to an other embodiments, the fuel consumption may be measured as a mass consumption per unit time, a weight consumption per unit time, or any other means of rate of fuel consumption.

Vessel speed sensor 35 detects the speed (e.g., knots, mph) of the vessel through the water. The speed through the water may be different than the speed over land due to the effects of currents by the water through which the vessel is passing. According to an exemplary embodiment, vessel speed sensor 35 may be, for example, a Doppler sonar velocity log system and measure the speed of the vessel by transmitting acoustic energy, receiving the reflected acoustic energy, and calculating the phase shift of the transmitted and received energies. According to other embodiments, vessel speed sensor 35 may be configured to include any means of determining vessel speed through water.

Position sensor 33 detects the position of the vessel over land. According to one exemplary embodiment, the position sensor may be a Global Positioning System (GPS) receiver that determines the position of the vessel by receiving signals from multiple (typically three or four) GPS satellites. For example, a GPS system may use geometric trilateration or multilateration to find the intersection of multiple satellites to determine the specific position of the vessel. The GPS receiver may then use the information from the satellites to determine the longitude and latitude of the vessel. According to other embodiments, position sensor 33 may be configured to include any means of determining vessel position and is not limited to GPS.

Generator electrical load sensor 37 detects the amount of power (e.g., electrical power) being generated by (or drawn from) the electric generator (e.g., the watt load), and may be configured using any means of detection or measuring electrical power.

Referring to FIG. 4, an operator display 50 is shown, according to an exemplary embodiment, to illustrate for the user various data that reflects the efficiency (e.g., fuel efficiency) of propulsion system 20 of the vessel. Operator display 50 may be configured to receive real-time updates from controller 45 of processed data from fuel consumption sensor 31, vessel speed sensor 35, position sensor 33, and the generator electrical load sensor 37, providing the user with substantially instantaneous feedback on the efficiency of propulsion system 20 and the how the actions of the user are affecting the efficiency of propulsion system 20. According to the exemplary embodiment of FIG. 4, the operator display 50 shows the vessel's efficiency over land 52, efficiency through water 53, fuel consumption per unit of time 54, and fuel consumption per unit of electric power 55.

The efficiency over land 52 may be calculated using data from the fuel consumption sensor 31 and the position sensor 33. According to an exemplary embodiment, efficiency over land 52 may be equal to the distance traveled (e.g., miles, kilometers) divided by the fuel consumption (e.g., gallons, liters). The efficiency through water 53 may be calculated using data from the fuel consumption sensor 31 and the vessel speed sensor 35. According to an exemplary embodiment, efficiency through water 53 may be equal to the vessel speed (e.g., knots, mph) multiplied by a corresponding period of time, then divided by the fuel consumed during the same period of time. The fuel consumption per unit of time 54 may be calculated using the fuel consumption sensor 31 and an internal clock. According to an exemplary embodiment, fuel consumption per unit of time 54 may be equal to the fuel consumed (e.g., gallons, liters) divided by the time (e.g., hours, minutes) it took to consume the fuel. The fuel consumption per electric power 55 may be calculated using the fuel consumption sensor 31 and the generator electrical load sensor 37. According to an exemplary embodiment, the fuel consumption per electric power 55 may be equal to the fuel consumed per period of time divided by the electric power generated during the same period of time.

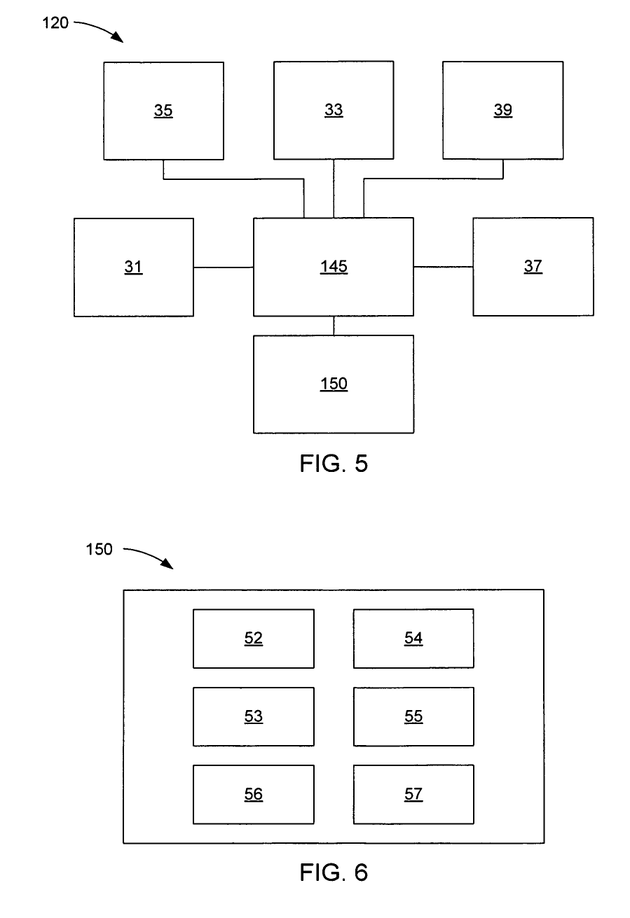

Referring to FIG. 5, propulsion system 120 is shown, according to an exemplary embodiment, to include a fuel consumption sensor 31, a vessel speed sensor 35, a position sensor 33, a generator electrical load sensor 37, a fuel tank level sensor 39, a controller 145, and an operator display 150. The sensors may detect data, as disclosed herein, then communicate the data by signals to the controller 145 that analyzes the signals, processes the data, and communicates the processed data by signals to operator display 150 where it can be viewed by a user. The communication of the signals of data may be transmitted directly through wiring harnesses, or through remote (e.g., wireless) means.

Fuel tank level sensor 39 detects the amount of fuel remaining in the fuel storage compartment (e.g., fuel-tank) of the generator 25. According to an exemplary embodiment, fuel tank level sensor 39 detects the volume of fuel remaining in the fuel storage compartment of generator 25. According to other exemplary embodiments, fuel tank level sensor 39 detects the mass or weight of fuel remaining in the fuel storage compartment, or another useful measure to determine the amount of remaining fuel.

Referring to FIG. 6, an operator display 150 is shown, according to an exemplary embodiment, to illustrate for the user various data that reflects the fuel efficiency of the propulsion system 120 of the vessel. Operator display 150 may be configured to receive real-time updates from the controller 145 of the processed data from fuel consumption sensor 31, vessel speed sensor 35, position sensor 33, the generator electrical load sensor 37, and fuel tank level sensor 39 providing the user substantially instantaneous feedback on the current efficiency of propulsion system 20 and the how the actions of the user are affecting the efficiency of propulsion system 20. According to the exemplary embodiment of FIG. 6, the operator display 50 shows the vessel's efficiency over land 52, efficiency through water 53, fuel consumption per unit of time 54, fuel consumption per unit of electric power 55, time remaining 56, and distance remaining 57.

The operator display 150 can show the user the distance remaining 57 at the current throttle speed (e.g., using data from the fuel tank level sensor and the position sensor) and the time remaining 56 at the current throttle speed (e.g., using data from the fuel tank level sensor and the fuel consumption sensor). According to an exemplary embodiment, the operator display 150 can display the distance remaining 57 as the distance remaining over land, where, for example, the distance remaining 57 may be equal to the efficiency over land 52 multiplied by the remaining fuel (in corresponding units of volume). According to another exemplary embodiment, the operator display 150 can display the distance remaining 57 as the distance remaining through water, where, for example, the distance remaining 57 may be equal to the efficiency through water 53 multiplied by the remaining fuel (in corresponding units). The operator display 150 may be configured to display the distance remaining 57 as both distance remaining over land and distance remaining through water, either simultaneously or alternatively (e.g., toggle between them).

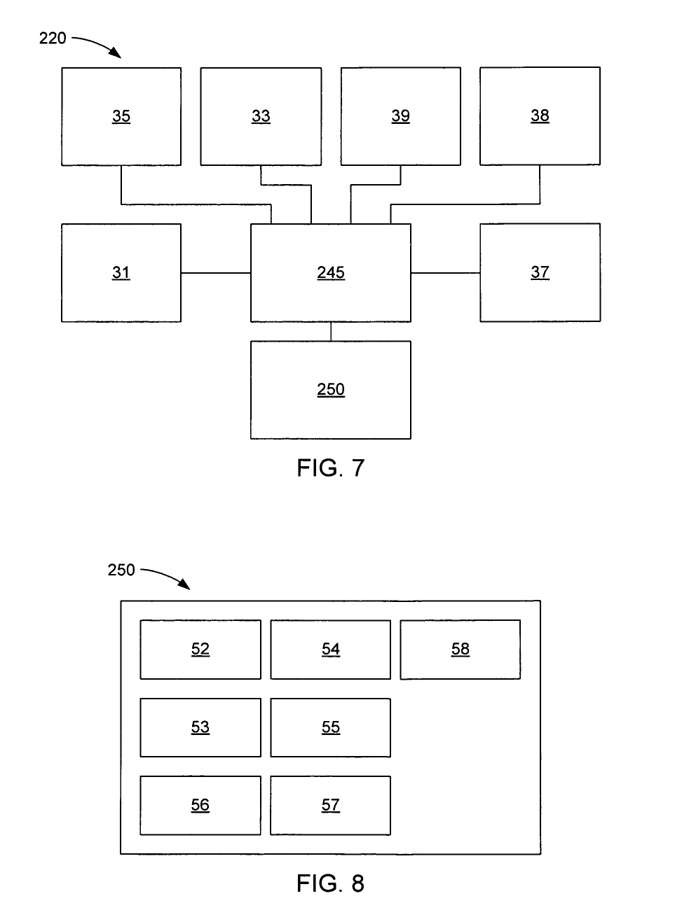

Referring to FIGS. 7 and 8, propulsion system 220 is shown, according to an exemplary embodiment, to further include a GPS navigation map 38. The GPS navigation map 38 may include map data and use the sensors disclosed herein to determine and display data concerning the position of the vessel's destination. Using the vessel destination data in conjunction with the vessel position data from position sensor 33, the controller 245 may be configured to determine the fuel required to reach the destination at the current throttle speed (e.g., using data from the fuel consumption sensor and the GPS navigation map), then transmit the processed data to the operator display 250 to display for the user the fuel required to destination 58 (i.e., the fuel required for the vessel to reach the destination at the current throttle speed). FIG. 8 is a representative drawing of operator display 250. The operator display 250 may display the fuel required to destination 58 in various units (e.g., gallons, liters), depending on the user or customer requirements. According to operator or manufacturer preferences, one or more of data/efficiency readings shown in FIG. 8 may be included in a particular embodiment of the system.

As disclosed herein, a propulsion system for a marine vessel may include an engine driving a generator for supplying electrical power to a propulsion motor and an operator display. The system further includes fuel consumption, vessel position and vessel speed sensors. The system includes a processor or controller that is configured to receive inputs from the fuel consumption, vessel position and vessel speed sensors and to calculate the vessel's efficiency through water and efficiency over land, wherein one or both efficiency values may be displayed on the operator display as volume of fuel consumed per distance traveled (over land or through the water).

The system described above may further include a generator electrical load sensor, whereby the controller may be configured to calculate the fuel consumption per unit of electrical power generated by the generator, wherein the calculated fuel consumption value is displayed on the operator display. The controller may also or alternatively be configured to calculate the fuel consumption per unit time, wherein the fuel consumption value is displayed on the operator display.

According to another embodiment, the system may include a fuel tank level sensor, whereby the controller may be configured to calculate the distance over land remaining before the fuel tank is empty, wherein the distance remaining may be displayed on the operator display. According to still another embodiment, the system may include a GPS based navigation system. The controller may be configured to calculate the fuel required to destination and wherein the required fuel may be displayed on the operator display.

According to yet another embodiment, the propulsion system may operate in a fully or semi automatic mode in order to optimize the efficiency of the vessel over land or through the water. For example, the controller may be configured to receive inputs regarding the intended destination of the vessel and the desired length of time of travel, which may be used in conjunction with the fuel consumption, vessel position, and vessel speed sensors to adjust the speed of the propulsion motor in order to optimize the efficiency of the propulsion system. Alternatively, the controller may be configured to receive inputs from the fuel consumption, vessel position, and vessel speed sensors and calculate the vessel's efficiency through water and efficiency over land, wherein the controller adjusts the speed of the engine (i.e., position of the throttle) based on the calculated efficiency values to adjust and control the speed of the vessel to optimize efficiency of the propulsion system.

It is important to note that the construction and arrangement of the system for monitoring the efficiency of the marine vessel as shown in the various exemplary embodiments is illustrative only. Although only a few embodiments of the present application have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the application. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store a desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should be noted that although the diagrams herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations of the present application could be accomplished with standard programming techniques with rule-based logic and other logic to accomplish the various connection steps, processing steps, comparison steps and decision steps.

The foregoing description of embodiments of the application has been presented for purposes of illustration and description. It is not intended to be exhaustive or to limit the application to the precise form disclosed, and modifications and variations are possible in light of the above teachings, or may be acquired from practice of the application. The embodiments were chosen and described in order to explain the principles of the application and its practical application to enable one skilled in the art to utilize the application in various embodiments and with various modifications as are suited to the particular use contemplated.

Although the description contains many specificities, these specificities are utilized to illustrate some of the preferred embodiments of this application and should not be construed as limiting the scope of the application. The scope of this application fully encompasses other embodiments which may become apparent to those skilled in the art. All structural, chemical, and functional equivalents to the elements of the above-described application that are known to those of ordinary skill in the art are expressly incorporated herein by reference and are intended to be encompassed by the present application. A reference to an element in the singular is not intended to mean one and only one, unless explicitly so stated, but rather it should be construed to mean at least one. Furthermore, no element, component or method step in the present disclosure is intended to be dedicated to the public.

What is claimed is:

1. A propulsion system for a marine vessel comprising:
an engine driving a generator for supplying electrical power to a propulsion motor;
an operator display;
a fuel consumption sensor;
a vessel position sensor;
a vessel speed sensor; and
a controller configured to receive inputs from the fuel consumption, vessel position and vessel speed sensors and calculate the vessel's efficiency through water and efficiency over land, wherein both efficiency values are displayed on the operator display as volume of fuel consumed per distance traveled (over land or through the water).

2. The system of claim 1, further comprising a generator electrical load sensor and wherein the controller is configured to calculate the fuel consumption per unit of electrical power generated by the generator, wherein the calculated fuel consumption value is displayed on the operator display.

3. The system of claim 1, wherein the controller is configured to calculate the fuel consumption per hour, wherein the fuel consumption value is displayed on the operator display.

4. The system of claim 1, further comprising a fuel tank level sensor.

5. The system of claim 4, wherein the controller is configured to calculate the distance over land remaining before the fuel tank is empty, wherein the distance remaining is displayed on the operator display.

6. The system of claim 4, further comprising a GPS based navigation system.

7. The system of claim 6, wherein the controller is configured to calculate the fuel required to destination and wherein the required fuel is displayed on the operator display.
